(19) United States
(12) Patent Application Publication
(10) Pub. No.: US 2011/0050605 A1
(43) Pub. Date: Mar. 3, 2011

(54) Touch Sensing Module, Display Apparatus and Manufacturing Method Thereof

(75) Inventors: Hsuan-I Pan, Hsinchu Hsien (TW); Guo-Kiang Hung, Hsinchu Hsien (TW)

(73) Assignee: MSTAR SEMICONDUCTOR, INC., Hsinchu Hsien (TW)

(21) Appl. No.: 12/820,530

(22) Filed: Jun. 22, 2010

(30) Foreign Application Priority Data
Sep. 2, 2009 (TW) 098129589

(51) Int. Cl. G06F 3/041

(52) U.S. Cl. 345/173

(57) ABSTRACT

A touch sensing module includes a first sensing layer having a plurality of first sensing electrodes, and a second sensing layer having a plurality of second sensing electrodes. Each of the gaps between neighboring second sensing electrodes is much smaller than the width of the second sensing electrodes to improve signal quality.

### CROSS REFERENCE TO RELATED PATENT APPLICATION

This patent application is based on Taiwan, R.O.C. patent application No. 098129589 filed on Sep. 2, 2009.

### FIELD OF THE INVENTION

The present invention relates to a touch sensing module, a display apparatus and a manufacturing method thereof, and more particularly, to a double-layer electrode touch sensing module, a display apparatus and a manufacturing method thereof.

### BACKGROUND OF THE INVENTION

FIG. 1 shows a schematic diagram of a conventional capacitive touch module comprising a first sensing layer 110, a second sensing layer 120, and a shielding layer 130. The first sensing layer 110 and the second sensing layer 120 are coupled to a sensing circuit 100, and are for detecting a position of a touched point to output a position signal.

FIG. 2 shows a top view of the first sensing layer 110 and the second sensing layer 120 in FIG. 1. The first sensing layer 110 has a plurality of first sensing electrodes 111 horizontally arranged along an X direction, and the second sensing layer 120 has a plurality of second sensing electrodes 121 vertically arranged along a Y direction. The first electrodes 111 and the second electrodes 121 are connected to the sensing circuit 100 in FIG. 1 via a plurality of first traces 112 and a plurality of second traces 122, respectively. As shown in FIG. 2, gaps between two sensing electrodes 111 and the gaps between two sensing electrodes 121 of the prior art are equal, such that similar level of sensing effects are resulted for the X and Y directions. An equivalent capacitor is provided at each intersection of the sensing electrodes 111 and 121. More specifically, when a user touches the capacitive touch panel, the equivalent capacitance at the touched point is changed to allow the sensing circuit 100 to detect an actual position of the touched point and to output a position signal.

The shielding layer 130 in FIG. 1 is mainly for isolating panel control signals from sensing signals so that sensing signals are not affected by noise from the control signals. Another source of noise imposed on the sensing signals is common voltage signals (Vcom). The common voltage signals are generated by an integrated display controller (not shown) to control the inversion of liquid crystals of a liquid crystal display (LCD). Since the amplitude of the common voltage signals ranges from 3V to 5V, without a shielding layer 130, transitions between high and low levels of the common voltage signals cause noise and the noise is often coupled to the sensing signals thereby hindering the sensing circuit 100 from generating accurate position signals.

Further, the conventional three-layer capacitive touch module having the shielding layer is more costly. Therefore, there is a need for a touch sensing module capable of eliminating noise interference as well as having reduced space and cost.

### SUMMARY OF THE INVENTION

A touch sensing module is provided by the invention. The touch sensing module comprises a first sensing layer having a plurality of first sensing electrodes, and a second sensing layer having a plurality of second sensing electrodes. The plurality of second electrodes have gaps far smaller than a width thereof.

A touch sensing display apparatus is further provided by the invention. The touch sensing display apparatus comprises: a touch sensing module, comprising a first sensing layer having a plurality of first sensing electrodes, and a second sensing layer having a plurality of second sensing electrodes; a sensing circuit, coupled to the plurality of first sensing electrodes and the plurality of second sensing electrodes; and an LCD module. The second sensing layer is situated between the first sensing layer and the LCD module, and the second sensing electrodes have gaps that are far smaller than a width thereof.

A manufacturing method for a touch sensing module is also provided by the invention. The manufacturing method comprises placing a plurality of first sensing electrodes at a first sensing layer, placing a plurality of second sensing electrodes at a second sensing in a way that the second sensing electrodes have gaps that are far smaller than a width thereof, and driving the second sensing electrodes to render the second sensing electrodes in a low-impedance state.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of a conventional capacitance touch sensing module;

FIG. 2 is a top view of the first sensing layer and the second sensing layer in FIG. 1;

FIG. 3 is a top view of a structure of a touch sensing module according to an embodiment of the invention;

FIG. 4 is a partial enlarged view of FIG. 3;

FIG. 5 is a schematic diagram of a touch sensing display apparatus according to an embodiment of the invention; and

FIG. 6 is a flowchart of a manufacturing method for a touch sensing module according to an embodiment of the invention.

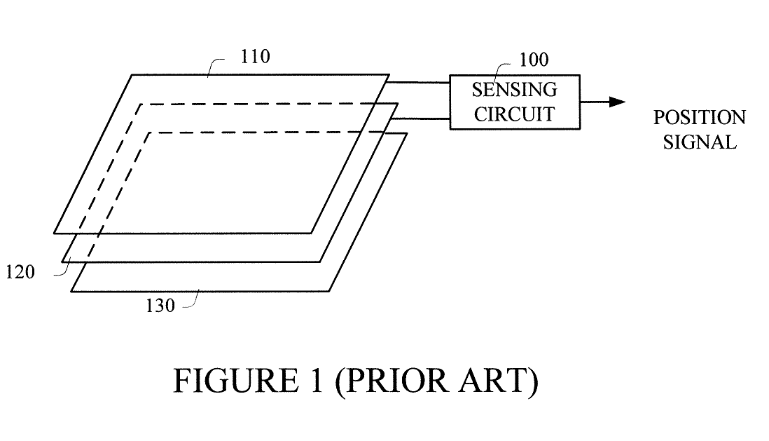

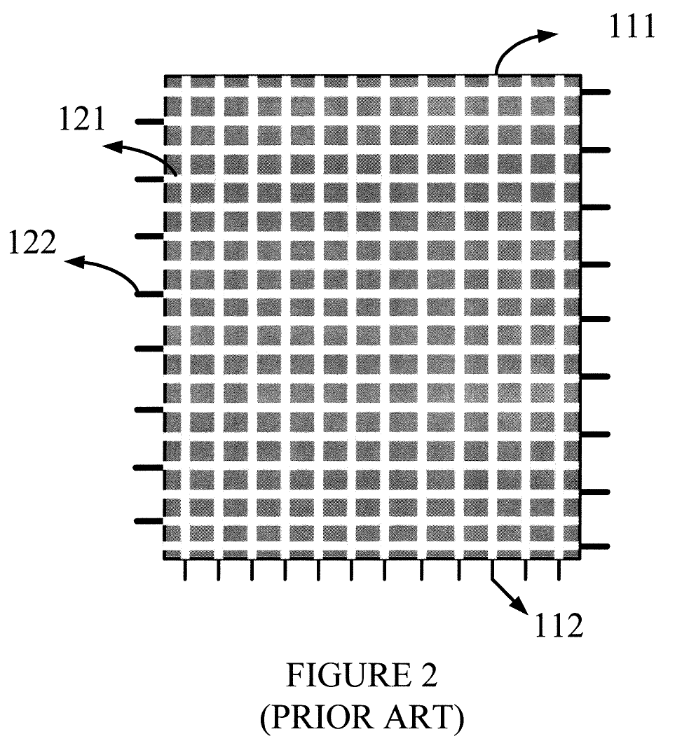

### DETAILED DESCRIPTION OF THE PREFERRED EMBODIMENT

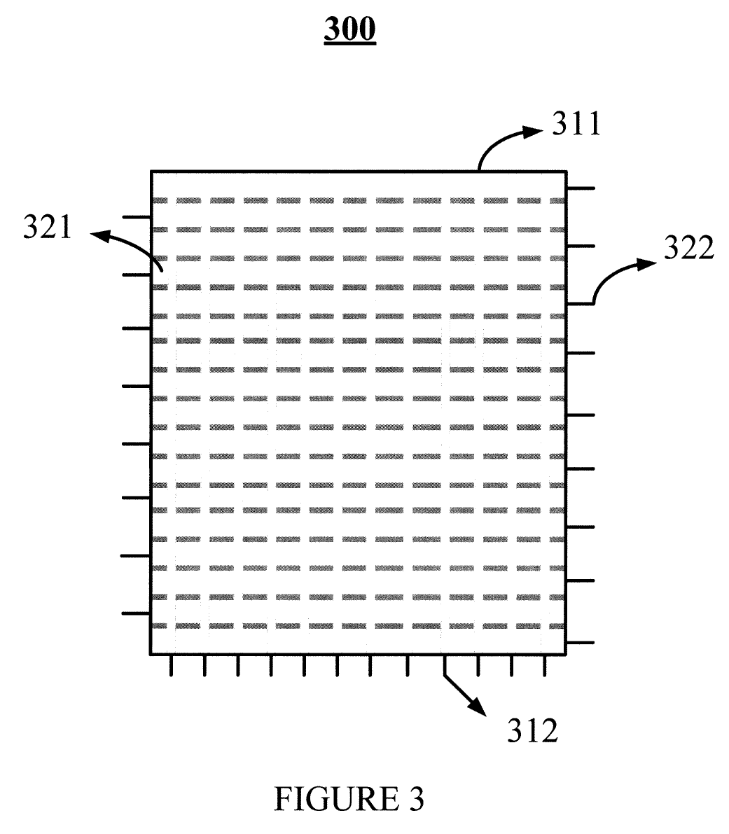

FIG. 3 shows a top view of a structure of a touch sensing module 300 according to an embodiment of the invention. The touch sensing module 300 comprises a plurality of first sensing electrodes horizontally arranged along an X direction at a first sensing layer, and a plurality of second sensing electrodes vertically arranged along a Y direction at a second sensing layer. The first sensing layer is disposed on the second sensing layer. To apply the touch sensing module 300 to a touch sensor display, the sensing electrodes need be optically transparent and conductive, and may be made of indium tin oxide (ITO), for example. It is to be noted that, the embodiment is also suitable for a touch sensing module without display capabilities, e.g., a touch sensing panel below a keyboard of a laptop computer, so that the touch sensing panel needs not be a transparent material in this case. The first sensing electrodes 311 and the second sensing electrodes 321 are connected to a sensing circuit (not shown) via a plurality of first trace lines 312 and a plurality of second trace lines 322, respectively. The trace lines are conductive but not necessarily transparent. Via the trace lines 312 and 322, the sensing circuit detects variations of equivalent capacitance between the sensing electrodes 311 and 321 caused by a touch, so as to obtain a position of the touch point.

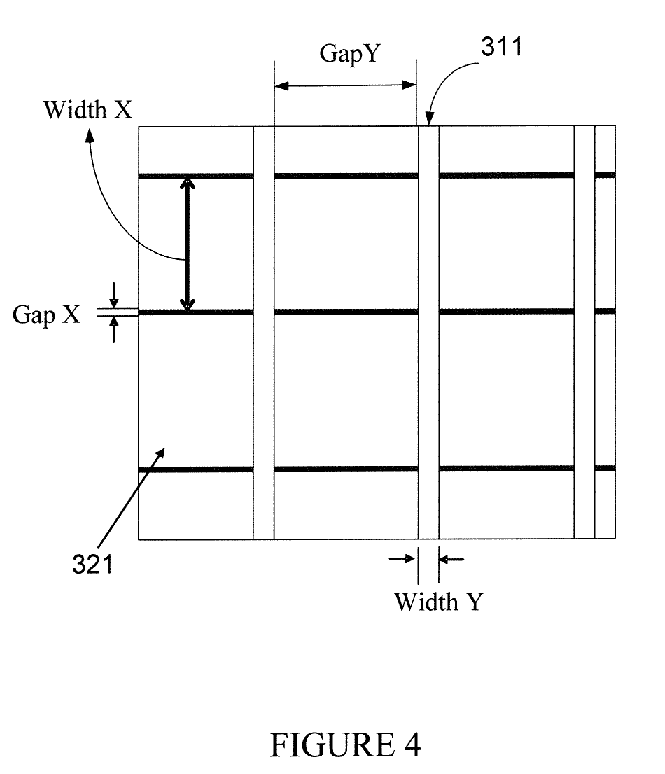

FIG. 4 shows a partial enlarged view of FIG. 3. According to an embodiment of the invention, the first sensing electrodes 311 are arranged in the Y direction. Each of the first sensing electrodes 311 has a first width WidthY of 0.5 mm, and a first gap GapY of 4 mm is formed between every two of the first sensing electrodes 311. The second sensing electrodes 321 are arranged in the X direction. Each of the second sensing electrodes 321 has a second width WidthX of 4 mm, and a second gap GapX of 0.2 mm is formed between every two of the second sensing electrodes 321. As shown in FIG. 4, second width WidthX of each of the second sensing electrodes 321 is far greater than the second gap GapX, and also far greater than the first width WidthY of the first sensing electrodes 311. That is, the second sensing electrodes 321 have second gap GapX far smaller than first gap GapY of the first sensing electrodes 311. Thus, in the particular embodiment depicted in FIG. 4, the WidthY is at least 10 times, and preferably at least 20 times, greater than GapY. Also, GapY is at least 10 times, and preferably 20 times, smaller than GapX. In still other embodiments, WidthY may be greater than GapY by more than 20 times.

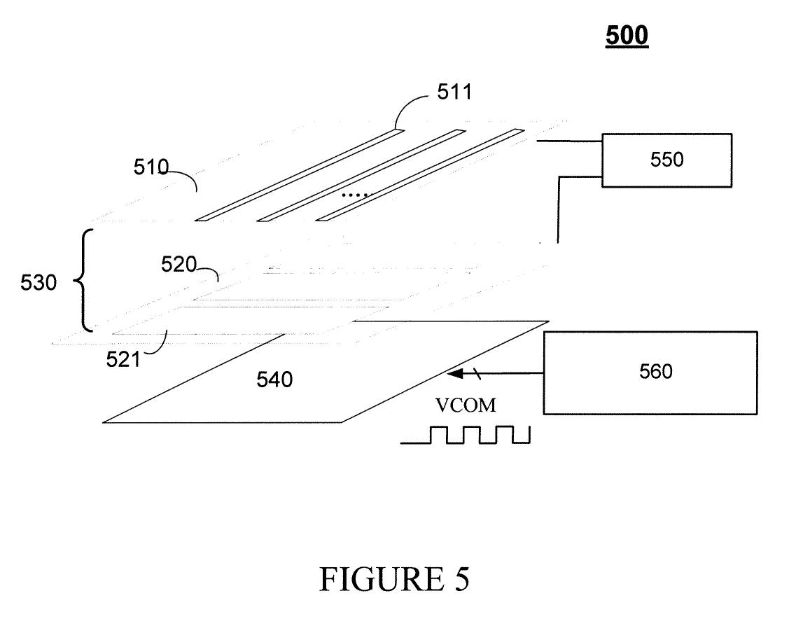

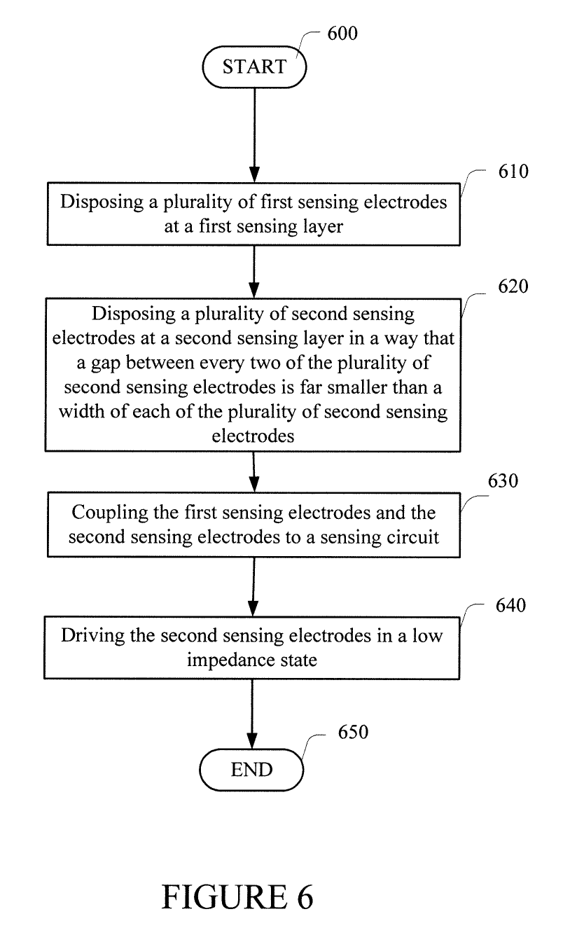

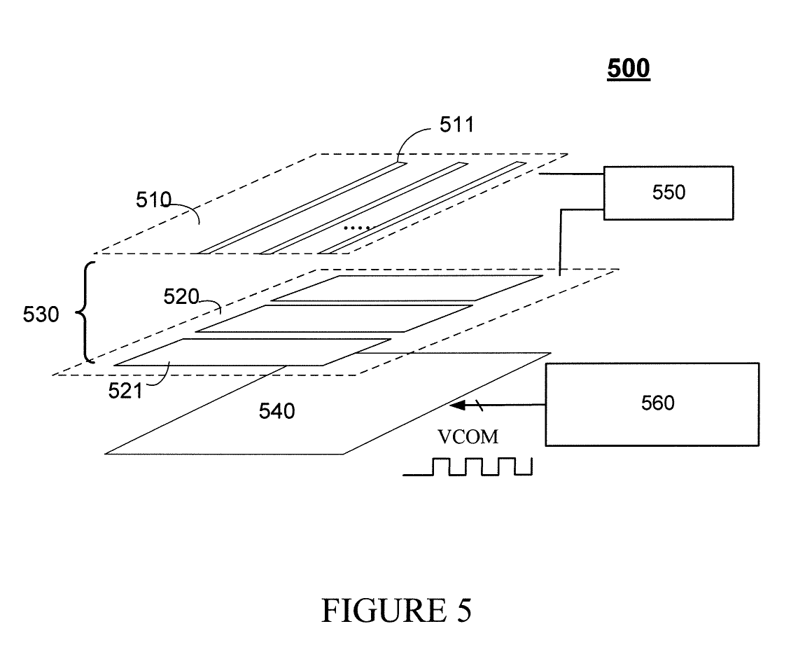

FIG. 5 shows a schematic diagram of a touch sensing display apparatus 500 according to an embodiment of the invention. The touch sensing display apparatus 500 comprises a touch sensing module 530, an LCD module 540, a sensing circuit 550 and a display controller 560. The touch sensing module 530 comprises a first sensing layer 510 having a plurality of first sensing electrodes 511, and a second sensing layer 520 having a plurality of second sensing electrodes 521. As shown in FIG. 5, each of the second sensing electrodes 521 has a width, and a gap is formed between every two second sensing electrodes 521. Similar to the embodiment shown in FIG. 4, the width of each of the second sensing electrodes 521 is far greater than the gap between every two of the second sensing electrodes 521. The area formed by the second sensing electrodes 521 occupies a major part of the area of the second sensing layer 520. The display controller 560 outputs a common voltage signal Vcom with an amplitude ranging from 3V to 5V to the LCD module 540. Preferably, the sensing circuit 550 renders the second sensing electrodes 521 at a low-impedance state by using an internal driving circuit (not shown), such that the signal of the second sensing electrodes 521 does not shift along with variations of the common voltage signal Vcom. Since the gaps do exist between the second sensing electrodes 521, electric force lines generated from a constant voltage used for the sensing circuit 550 to drive the second sensing electrodes 521 are present in the gaps. The electric force lines are emitted from one side of the second sensing electrodes 521, and the electric force lines near edges of the second sensing electrodes 521 exit at the other side of the second sensing electrodes 521. When the second sensing electrodes 521 have gaps far smaller than their width, it is difficult for the common voltage Vcom to penetrate through the electric field at the gaps of the second sensing electrodes 521 to further affect the electric potential of the first sensing electrodes 511. Therefore, when the second sensing electrodes 521 are voltage driven, a shielding effect is formed by shielding the first sensing layer 510 against the common voltage signal outputted by the display controller 560 to the LCD module 540, thereby enhancing quality of sensing signals of the touch module 530.

FIG. 6 shows a flowchart of a manufacturing method for a touch sensor module according to an embodiment of the invention. The flow starts at Step 600. Step 610 provides disposing a plurality of first sensing electrodes at a first sensing layer. Step 620 provides disposing a plurality of second sensing electrodes at a second sensing layer. The second sensing electrodes have a gap, in between each other, far smaller than their width, such that the second electrodes occupy a major part of the area of the second sensing layer. The first sensing layer is disposed parallel to the second sensing layer, and the first sensing electrodes are substantially arranged perpendicular to the second sensing electrodes. The first and second sensing electrodes may be made of an optically transparent and conductive material, e.g., ITO, for applications to a touch sensing display module. Alternatively, the first and second sensing electrodes are not necessarily a transparent material when applied to a non-display-oriented touch sensing panel, e.g., a touch sensing panel below a keyboard of a laptop computer. Step 630 provides coupling the first and second sensing electrodes to a sensing circuit to detect a sensing signal. Step 640 provides applying a voltage to the second sensing electrodes to render the second sensing electrodes at a low-impedance state with an internal driving circuit of the sensing circuit, so as to shield the first sensing layer from noise interference. The flow ends at Step 650.

Therefore, according to the touch sensor apparatus of the invention, no additional shielding layer is needed to shield against interference. More specifically, when manufacturing the second sensing layer, etched patterns on the ITO are modified, such that the second sensing electrodes have gaps that are far smaller than their width, and thus occupy a major part of the area of the second sensing layer. A driving voltage is applied to render the second sensing electrodes at a low-impedance state so that the second sensing electrodes become capable of shielding noise interference coming from below the second electrodes.

With the description of the embodiments above, it is easily appreciated for a person skilled in the art that, when the touch sensing module is applied to a touch sensing display, the sensing electrodes are made of an optical transparent and conductive material in order to shield against interference imposed on a sensing signal by the common voltage signal Vcom outputted from the display controller to the LCD module; when the touch sensor module is applied to a touch sensing panel below a keyboard of a laptop computer, the shielding layer is also needed to prevent the control signal from coupling to the sensing signal since the control circuit that generates noise interference is present below the sensing layer. Therefore, for accommodating different applications, the sensing electrodes according to the invention may be a transparent and conductive material, and a non-transparent and conductive material.

Therefore, the invention is capable of eliminating the shielding layer of the prior art and/or improving signal quality. Advantages of eliminating the shielding layer are that not only a portable device is made more compact for better mobility but also a display panel on the portable device is provided with a better transmittance, so as to achieve objects of reducing space and cost.

A touch sensor module according to the disclosure comprises a first sensing layer having a plurality of first sensing electrodes, and a second sensing layer having a plurality of second sensing electrodes. The plurality of second electrodes have gaps far smaller than a width thereof.

A touch sensing display apparatus according to the disclosure comprises a touch sensor module including a first sensing layer having a plurality of first sensing electrodes and a second sensing layer having a plurality of second sensing electrodes; a sensing circuit, coupled to the plurality of first sensing electrodes and the plurality of second sensing electrodes; and an LCD module. The second sensing layer is situated between the first sensing layer and the LCD module, and the second sensing electrodes have gaps that are far smaller than a width thereof.

A manufacturing method for a touch sensing module according to the disclosure comprises placing a plurality of first sensing electrodes at a first sensing layer, placing a plurality of second sensing electrodes at a second sensing layer in a way that the second sensing electrodes have gaps that are far smaller than a width thereof, and driving the second sensing electrodes to render the second sensing electrodes in a low-impedance state.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A touch sensor module, comprising:
a first sensing layer, comprising a plurality of first sensing electrodes, each of the first sensing electrodes having a first width, a first gap being formed in between every two of the first sensing electrodes; and
a second sensing layer, comprising a plurality of second sensing electrodes, each of the second sensing electrodes having a second width, a second gap being formed in between every two of the second sensing electrodes;
wherein, the second width is at least 10 times greater than the second gap.

2. The touch sensor module as claimed in claim 1, wherein each second gap is no more than 1/10 the size of the first gap.

3. The touch sensor module as claimed in claim 1, wherein the second width of the plurality of second electrodes is at least 10 times greater than the first width of the plurality of first electrodes.

4. The touch sensor module as claimed in claim 1, wherein the second width of the plurality of second electrodes is substantially the same.

5. The touch sensor module as claimed in claim 1, further comprising a sensing circuit coupled to the plurality of first sensing electrodes and the plurality of second sensing electrodes.

6. The touch sensor module as claimed in claim 5, wherein the sensing circuit comprises a driving circuit for rendering the plurality of second sensing electrodes in a low-impedance state.

7. The touch sensor module as claimed in claim 1, wherein the plurality of first sensing electrodes are substantially perpendicular to the plurality of second sensing electrodes.

8. The touch sensor module as claimed in claim 1, wherein the plurality of first sensing electrodes and the plurality of second sensing electrodes are made of a transparent and conductive material.

9. The touch sensor module as claimed in claim 1, wherein the plurality of first sensing electrodes and the plurality of second sensing electrodes are made of a non-transparent and conductive material.

10. A touch sensor display apparatus, comprising:
a touch sensor module, comprising a first sensing layer having a plurality of first sensing electrodes, and a second sensing layer having a plurality of second sensing electrodes, each of the second sensing electrodes having a second width, a second gap being foamed in between every two of the second sensing electrodes, the second width being at least 10 times greater than the second gap;
a sensing circuit, coupled to the plurality of first sensing electrodes and the plurality of second sensing electrodes; and
a LCD module, disposed under the second sensing layer.

11. The touch sensor display apparatus as claimed in claim 10, a first gap being formed in between each two of the first sensing electrodes, wherein the second gap is no more than 1/10 the size of the first gap.

12. The touch sensor display apparatus as claimed in claim 10, each of the first sensing electrodes have a first width, wherein the second width of each of the plurality of second electrodes is at least 10 times greater than the first width of each of the plurality of first electrodes.

13. The touch sensor display apparatus as claimed in claim 10, wherein the sensing circuit comprises a driving circuit for driving and rendering the plurality of second sensing electrodes in a low-impedance state.

14. The touch sensor display apparatus as claimed in claim 10, wherein the plurality of first sensing electrodes are perpendicular to the plurality of second sensing electrodes.

15. The touch sensor display apparatus as claimed in claim 10, wherein the plurality of first sensing electrodes and the plurality of second sensing electrodes are made of a transparent and conductive material.

16. A method of manufacturing a touch sensor module, comprising:
disposing a plurality of first sensing electrodes at a first sensing layer; and
disposing a plurality of second sensing electrodes at a second sensing layer in a way that a gap between every two of the plurality of second sensing electrodes is no more than 1/10 a width of each of the plurality of second sensing electrodes.

17. The method as claimed in claim 16, further comprising disposing the second sensing electrodes in a way that the gap between every two of the plurality of second sensing electrodes is no more than 1/10 the size of a gap between every two of the plurality of first electrodes.

18. The method as claimed in claim 16, further comprising disposing the second sensing electrodes in a way that a width of each of the plurality of second electrodes is at least 10 times greater than a width of each of the plurality of first electrodes.

19. The method as claimed in claim 16, further comprising driving and rendering the plurality of second sensing electrodes in a low-impedance state.

20. The method as claimed in claim 16, further comprising arranging the plurality of first sensing electrodes in perpendicular to the plurality of second electrodes.
